(19) United States
(12) Patent Application Publication
(10) Pub. No.: US 2018/0113289 A1
(43) Pub. Date: Apr. 26, 2018

(54) ANTI-PEEPING DEVICE AND METHOD FOR MANUFACTURING THE SAME AND DISPLAY DEVICE

(71) Applicant: BOE Technology Group Co., Ltd., Beijing (CN)

(72) Inventor: Yanbing Wu, Beijing (CN)

(21) Appl. No.: 15/520,422

(22) PCT Filed: Jul. 4, 2016
(86) PCT No.: PCT/CN2016/088358

§ 371 Date: Apr. 20, 2017

(30) Foreign Application Priority Data
Mar. 18, 2016 (CN) 201610158326.6

(51) Int. Cl. G02B 17/04; G02B 5/04

(52) U.S. Cl. CPC G02B 17/04; G02B 5/045

(57) ABSTRACT

An anti-peeping device, including a transparent body and a plurality of shutter members, a plurality of accommodating grooves being formed on the transparent body, the shutter members being spaced apart, portions of the transparent body between two adjacent shutter members being light transmitting units, and each of the light transmitting units including a light incident surface and a light exiting surface. A side of each of the shutter members adjacent to a corresponding accommodating groove is formed as a light reflecting surface, and the light reflecting surface of the shutter member is provided such that an angle between a reflection direction of the light reflected from the light reflecting surface and the light exiting surface of the corresponding light transmission unit is larger than an angle between an incident direction of the light incident on the light reflecting surface and the light incident surface of the corresponding light transmission unit.

### CROSS-REFERENCE TO RELATED APPLICATIONS

The present application is based on International Application No. PCT/CN2016/088358, filed on Jul. 4, 2016, which is based upon and claims priority to Chinese Patent Application No. 201610158326.6, filed on Mar. 18, 2016, and the entire contents thereof are incorporated herein by reference.

### TECHNICAL FIELD

The present disclosure relates to the technical field of display, and more particularly to an anti-peeping device and a method for manufacturing the same and a display device.

### BACKGROUND

With the advancement of science and technology, a portable display device is becoming more and more popular. People often use the portable display device to read, learn or handle official business in public places. However, since crowds gather in the public places, contents viewed by one can be easily seen by others, one's privacy can not be well protected. People can use an anti-peeping device (for example, an anti-peep film) for confidential display to prevent contents viewed by them from being seen by others. It should be noted that, information disclosed in the above background portion is provided only for better understanding of the background of the present disclosure, and thus it may contain information that does not form the prior art known by those ordinary skilled in the art.

### SUMMARY

The object of the present disclosure is to provide an anti-peeping device and a method for manufacturing the same and a display device, so that the utilization of light can be improved while achieving an anti-peeping effect.

According one aspect of the present disclosure, an anti-peeping device is provided, comprising a plurality of accommodating grooves for accommodating the shutter members being formed on the transparent body, the shutter members being spaced apart, portions of the transparent body between two adjacent shutter members being light transmitting units, and each of the light transmitting units comprising a light incident surface and a light exiting surface. A side of each of the shutter members adjacent to a corresponding accommodating groove is formed as a light reflecting surface which is used to reflect at least a portion of light directed from the light incident surface of a corresponding light transmission unit toward the shutter member, the reflected light is directed toward the light exiting surface of the corresponding light transmission unit, and the light reflecting surface of the shutter member is provided such that an angle between a reflection direction of the light reflected from the light reflecting surface and the light exiting surface of the corresponding light transmission unit is larger than an angle between an incident direction of the light incident on the light reflecting surface and the light incident surface of the corresponding light transmission unit.

According another aspect of the present disclosure, a method for manufacturing an anti-peeping device is provided, comprising: preparing a transparent body, forming a plurality of accommodating grooves which are spaced apart on the transparent body; and forming a shutter member in each of the accommodating grooves, a side of the shutter member adjacent to a corresponding accommodating groove being formed as a light reflecting surface. Portions of the transparent body between adjacent two shutter members are light transmitting units, each of the light transmitting units comprises a light incident surface and a light exiting surface, the light reflecting surface of each shutter member is used to reflect at least a portion of light directed from the light incident surface of a corresponding light transmission unit toward the shutter member, the reflected light is directed toward the light exiting surface of the corresponding light transmission unit, and the light reflecting surface of the shutter member is provided such that an angle between a reflection direction of the light reflected from the light reflecting surface and the light exiting surface of the corresponding light transmission unit is larger than an angle between an incident direction of the light incident on the light reflecting surface and the light incident surface of the corresponding light transmission unit.

According another aspect of the present disclosure, a display device is provided, comprising a display panel and the anti-peeping device according to the present disclosure, and the anti-peeping device is provided on a light exiting surface of the anti-peeping device.

### BRIEF DESCRIPTION OF THE DRAWINGS

The accompanying drawings are used to provide a further understanding of the present disclosure and constitute a part of this specification. The accompanying drawings together with the following embodiments serve to explain the present disclosure, and are not used to limit the present disclosure. In the drawings:

FIG. 1 is a view showing an anti-peeping device in the related art.

FIG. 2 is a view showing light emitted from a light emitting area when an anti-peeping device is not provided.

FIG. 3 is a view showing an anti-peeping device according to an embodiment of the present disclosure.

FIG. 4 is a view showing a transparent body in an anti-peeping device according to an embodiment of the present disclosure.

FIG. 5 is a view showing an anti-peeping device according to another embodiment of the present disclosure.

FIG. 6 is a view showing an anti-peeping device according to another embodiment of the present disclosure.

FIG. 7 is a view showing an anti-peeping device according to another embodiment of the present disclosure.

FIG. 8 is a view showing a first mold used to manufacture an anti-peeping device according to an embodiment of the present disclosure.

### DETAILED DESCRIPTION

Hereinafter, embodiments of the present disclosure will be described in detail with reference to the accompanying drawings. It should be understood that the embodiments described herein are only used to illustrate and explain the present disclosure and are not intended to limit the present disclosure.

FIG. 1 is a view showing an anti-peeping device in the related art. An anti-peep film shown in FIG. 1 can be provided on the display surface of a display device. A baffle 2 is provided within a film body 1 in the anti-peep film, which is used to absorb light. Thus, a part of light emitted from a light emitting area 3 is absorbed by the baffle 2, so that a viewing angle is reduced to achieve the effect of anti-peeping. However, since the baffle 2 absorbs a part of the light emitted from the light emitting area 3, a large light loss is caused and the utilization of light is reduced.

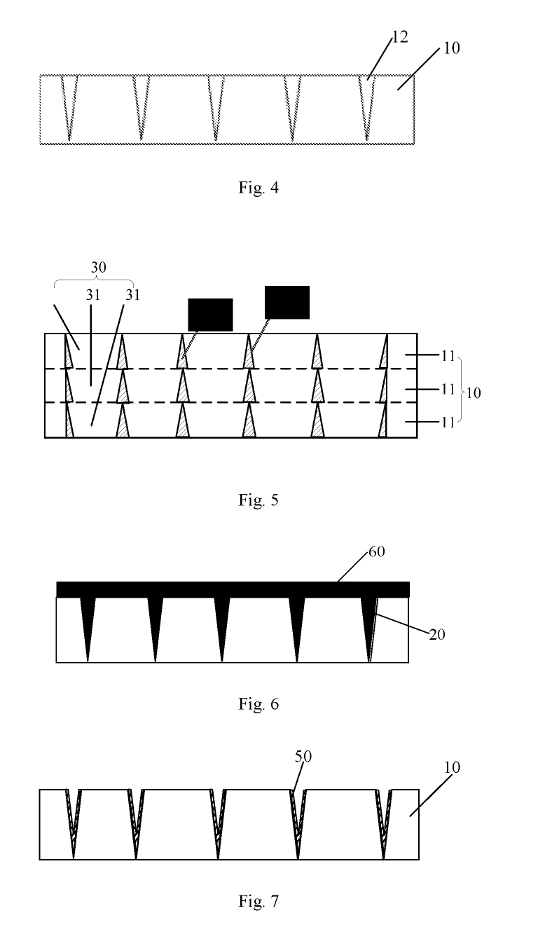

FIG. 3 is a view showing an anti-peeping device according to an embodiment of the present disclosure. FIG. 4 is a view showing a transparent body in an anti-peeping device according to an embodiment of the present disclosure.

Referring to FIGS. 3 and 4, the anti-peeping device according to the embodiment of the present disclosure comprises a transparent body 10 and a plurality of shutter members 20. A plurality of accommodating grooves 12 for accommodating the shutter members 20 are formed on the transparent body 10. Each of the shutter members 20 is spaced apart, and the portions of the transparent body 10 between two adjacent shutter members 20 are light transmitting units 30. Each of the light transmitting units 30 comprises a light incident surface (that is, a surface adjacent to a light emitting area 3 of each of the light transmitting units 30) and a light exiting surface (i.e., a surface through which the light is emitted from each of the light transmitting units 30). For each of the shutter members 20, a side of the shutter member 20 adjacent to a corresponding accommodating groove 12 is formed as a light reflecting surface which is used to reflect at least a portion of the light directed from the light incident surface of a corresponding light transmission unit 30 toward the shutter member 20, and the reflected light is toward the light exiting surface of the light transmission unit 30. Also, for each of the shutter members 20, the light reflecting surface of the shutter member 20 is provided such that the angle between a reflection direction of the light reflected from the light reflecting surface and the light exiting surface of a corresponding light transmission unit 30 (the angle θ in FIG. 3) is larger than the angle between the incident direction of the light incident on the light reflecting surface and the light incident surface of the corresponding light transmission unit 30 (the angle η in FIG. 3).

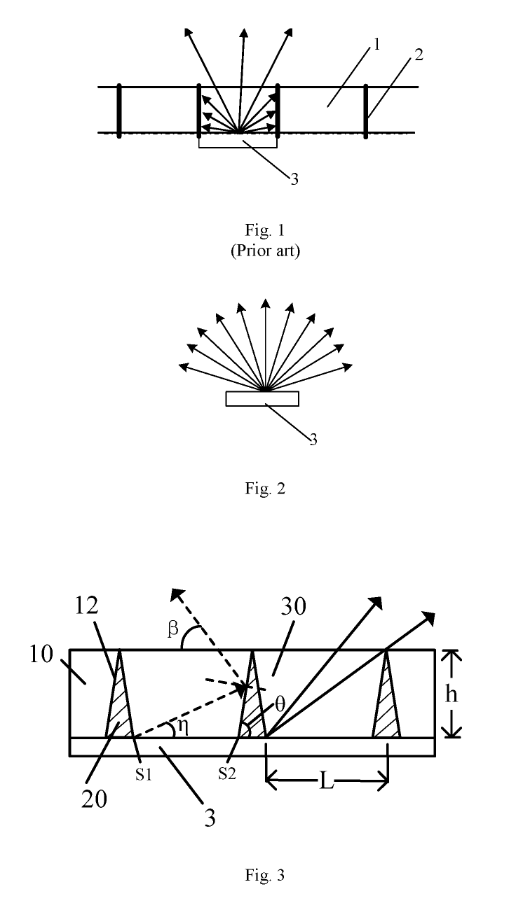

FIG. 2 is a view showing light emitted from a light emitting area when an anti-peeping device is not provided. As shown in FIG. 2, under the condition that the shutter members 20 are not provided, after the light passes through the transparent body 10, the exiting direction is the same as the incident direction. Thus, when the range of incident angle of the incident light is large, the range of the exiting angle of the light emitted from the light exiting surface is also large, so that the viewing angle of the display device is large.

The anti-peeping device according to the embodiment of the present disclosure can be applied to a display device to decrease the viewing angle, thus, preventing others from seeing contents displayed on the display device. According to the embodiment of the present disclosure, as shown in FIG. 3, each of the shutter members 20 is provided within a corresponding accommodating groove 12 of the transparent body 10. The height of each of the shutter members 20 is h, and the minimum horizontal distance between the top end of each of the shutter members 20 and the bottom end of an adjacent shutter member 20 is L. In each of the light transmission units 30, a viewing angle is defined by the light emitted from the leftmost incident point S1 of the light incident surface and the light emitted from the rightmost incident point S2 of the light incident surface. Taking the incident point S1 as an example, when the angle between the incident direction of the light at the incident point S1 and the light incident surface is η and η≥arctan (h/L), this portion of the light (light indicated by the solid arrow in FIG. 3) can be emitted directly from the light exiting surface; when η<arctan (h/L), this portion of the light (light indicated by the dashed arrow in FIG. 3) will be illuminated on the side of the corresponding shutter member 20. Since the side of the shutter member 20 is a light reflecting surface, the side of the shutter member 20 does not absorb light, but reflects (at least a portion of) the light to the light exiting surface, and causing the angle between the reflection direction and the light exiting surface to be larger than the angle between the incident direction and the light incident surface, that is, β>η. Therefore, after the light is reflected by the light reflecting surface of the shutter member 20, the irradiation range thereof is reduced, thereby reducing the viewing angle of the display device and realizing an anti-peeping effect. In addition, the utilization of the light can be improved by using the light reflecting surface of the shutter member 20 to reflect the light, as compared with the baffle 2 (shown in FIG. 1) provided in the film body 1 in the related art.

According to an embodiment of the present disclosure, the light reflecting surface of the each of the shutter members 20 can be a reflective surface of a mirror, so that all the light irradiated on the reflecting surface can be reflected toward the light exiting surface to maximize the utilization of the light and improve the display effect.

As shown in FIG. 3, the reflecting surface of each of the shutter members 20 may be an inclined plane, but the present invention is not limited thereto. The light reflecting surface of each of the shutter members 20 may also be a convex or concave curved surface as long as the light can be reflected toward the exiting surface and the angle between the reflective direction and the light exiting surface is larger than the angle between the incident direction and the light incident surface.

As a specific embodiment of the present invention, the reflecting surface of each of the shutter members 20 may be an inclined surface, that is, the angle θ between the side surface of each of the shutter members 20 as the light reflecting surface and the light incident surface of the transparent body 10 may be substantially less than 90°. The inclination directions of the light reflecting surfaces provided respectively on the two sides of one light transmission unit 30 may be different so that the light incident surface of the light transmission unit 30 is smaller than the light exiting surface of the light transmission unit, as shown in FIG. 3. When the angle between the incident direction of the light at the incident point S1 and the light incident surface is 11 and η<arctan (h/L), the angle between the reflection direction of the light reflected by the light reflecting surface and the light exiting surface is 180°-2θ+η, and therefore, β>η. That is, the angle between the reflection direction and the light exiting surface is larger than the angle between the incident direction and the light incident surface, so that the viewing angle of the display device using the anti-peeping device can become smaller. In addition, it can be seen that the smaller the angle θ between the light reflecting surface and the light incident surface, the greater the difference between β and η will be, and the reflected light is more concentrated toward a center, which is more conducive to achieve a narrow viewing angle, and provide a better anti-peeping effect.

As shown in FIG. 3, the light reflecting surfaces on the two sides of the light transmission unit 30 may be mirrored with respect to the center line of the light transmission unit 30. That is, the cross section of the light-transmission unit 30 has an isosceles trapezoid shape. Therefore, when the incident light is uniformly distributed on the incident surface of the light entrance unit 30, the amounts of light reflected respectively on the two sides of the light transmission unit 30 are the same, so that the distribution of the light emitted from the light exiting surface of the light transmission unit 30 is more uniform.

Each of the shutter members 20 may have a variety of shapes, for example, a triangular prism with a trapezoidal bottom or a triangular prism with a triangular bottom. FIG. 3 shows an example in which each of the shutter members 20 is a triangular prism.

As described above, the smaller the angle θ between the side of each of the shutter members 20 and the light incident surface, the more favorable a narrow viewing angle is achieved. However, in the case where the height h of each of the shutter members 20 is constant, the smaller the angle θ is, the larger the width of the bottom surface of each of the shutter members 20 is, and thus the utilization of the light is affected.

FIG. 5 is a view showing an anti-peeping device according to another embodiment of the present disclosure.

According to another embodiment of the present disclosure, the transparent body 10 comprises a plurality of sub bodies 11 stacked in a direction perpendicular to the transparent body (that is, the longitudinal direction of the transparent body) 10 in order to reduce the width of each of the shutter members 20 while maintaining a narrow viewing angle, as shown in FIG. 5. Each of the sub bodies 11 is formed with a plurality of accommodating grooves 12 for accommodating the shutter members 20 and the positions of the accommodating grooves 12 coincide with each other in a direction perpendicular to the transparent body 10. Each of the shutter members 20 is provided in a corresponding accommodating groove 12. A light transmission unit 30 may comprise a plurality of subunits 31 stacked in a direction perpendicular to the transparent body 10. Each of the subunits 31 corresponds to a portion of the corresponding sub body 11 located between two adjacent shutter members 20 and comprises a light incident surface and a light exiting surface. In two adjacent subunits positioned in a direction perpendicular to the transparent body 10, the light exiting surface of a lower subunit 31 is adjacent to the light incident surface of an upper subunit 31. In the direction perpendicular to the transparent body 10, the light incident surface of each of subunits 31 may be smaller than its light exiting surface.

Each of the shutter members 20 in FIG. 5 may have the same shape as that of each shutter member 20 shown in FIG. 3 and a different size from that of each shutter member 20 shown in FIG. 3. When the anti-peeping device have a same total height, the width of each of the shutter members 20 provided in the sub body 11 (shown in FIG. 5) is smaller than the width of each of the shutter members 20 provided in the transparent body 10 (shown in FIG. 3), so that the width of each of the shutter members 20 can be reduced while a narrow viewing angle being achieved, and the utilization ratio of light transmission is improved.

Similar to the structure shown in FIG. 3, the shape of the cross section of each of the subunits 31 may be an isosceles trapezoidal. In addition, as shown in FIG. 5, each of the shutter members 20 may have a same width, but the present disclosure is not limited thereto. For example, the width of each of the shutter members 20 may be increased gradually, in the direction perpendicular to the transparent body 10, from the light incident surface of each of the subunits 31 to its light exiting surface.

FIGS. 6 and 7 are views showing an anti-peeping device according to another embodiment of the present disclosure.

As shown in FIGS. 4 and 6, light reflective material may be filled in the accommodating grooves 12 to form the shutter members 20. As shown in FIG. 4, the light reflective material may be solid; or as shown in FIG. 6, the light reflective material may be liquid and the anti-peeping device may also comprise an encapsulation layer 60 for packaging the light reflective material within the accommodating grooves 12.

As shown in FIG. 7, each of the shutter members may comprise a light reflective material layer 50 provided on the inner wall of the corresponding accommodating groove 12.

According another aspect of the present disclosure, a method for manufacturing an anti-peeping device is provided, comprising the following steps.

A transparent body 10 is prepared and a plurality of accommodating grooves 12 are provided on the transparent body 10 at intervals (as shown in FIG. 4); and

a shutter member 20 is formed within each of the accommodating grooves 12, and a side of the shutter member 20 adjacent to the corresponding accommodating groove 12 is formed as a light reflecting surface. The portions of the transparent body 10 between two adjacent shutter members 20 are light transmitting units 30 (as shown in FIG. 3), and each of the light transmitting units 30 comprises a light incident surface and a light exiting surface. The light reflecting surface of the shutter member 20 is used to reflect at least a portion of the light directed from the light incident surface of the corresponding light transmission unit 30 toward the shutter member 20, and the reflected light is toward the light exiting surface of the light transmission unit 30. The light reflecting surface of the shutter member 20 is provided such that the angle between the reflection direction of the light reflected from the light reflecting surface and the light exiting surface of the corresponding light transmission unit 30 is larger than the angle between the incident direction of the light incident on the light reflecting surface and the light incident surface of the corresponding light transmission unit 30.

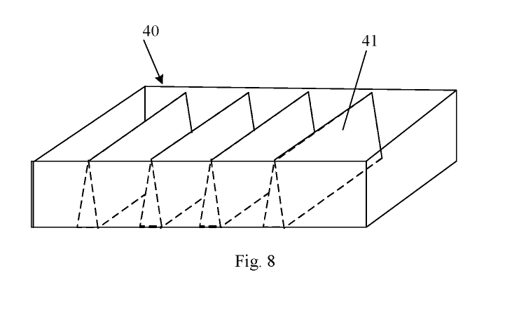

FIG. 8 is a view showing a first mold used to manufacture the anti-peeping device according to an embodiment of the present disclosure.

According to an embodiment of the present disclosure, the preparation of the transparent body 10 can comprise the following steps.

A first mold comprising a first cavity 40 is provided, and the shape of the first cavity 40 is matched to the shape of the transparent body 10; and

The first cavity 40 is filled with material for forming the transparent body 10.

The first cavity 40 may comprise a first projection 41, thus an accommodating groove 12 is formed on the transparent body 10 to mate with the first projection 41. The material for forming the transparent body 10 may be, for example, liquid transparent resin material, and the transparent body 10 may be formed by an injection molding process; or the material may be powdery resin material, and using a press molding process, the powder may be placed in the first cavity 40 and be processed under heat and pressure, and then is cured to form the transparent body 10.

According to an embodiment of the present disclosure, the formation of the shutter member 20 can comprise the following steps.

Liquid light reflective material (such as mercury, a melting metal having a low melting point, etc.) is filled in the accommodating groove 12; and

The liquid light reflective material is cured, or an encapsulation layer 60 is provided to encapsulate the light reflective material in the accommodating groove 12.

According to another embodiment of the present disclosure, the formation of the shutter member 20 can comprise the following steps.

A light reflective material layer 50 is formed on the inner wall of the accommodating groove 12 (as shown in FIG. 7). In particular, the light reflective material layer 50 may be formed by a process of evaporation or sputtering.

According to another embodiment of the present disclosure, when the anti-peeping device shown in FIG. 5 is being formed, the preparation of the transparent body 10 can comprise the following steps.

A plurality of second molds are provided, each of the second molds comprises a second cavity, and the shape of the second cavity is matched to that of the sub-body 11; and

the material for forming the sub-body 11 is filled in each second cavity.

In this case, the formation of the shutter member 20 can comprise the following steps.

A liquid light reflective material is filled in the accommodating grooves 12 of each sub body 11; and

the liquid light reflective material is cured, and a plurality of sub bodies 11 are stacked and fixed in a direction perpendicular to the transparent body 10.

According to another embodiment of the present disclosure, the formation of the shutter member 20 can comprise the following steps.

A light reflective material layer is formed on the inner wall of the accommodating groove 12 of each sub-body 11.

a plurality of sub bodies 11 are stacked and fixed in a direction perpendicular to the transparent body 10.

The plurality of sub bodies 11 are stacked and fixed by a transparent binder; or, after being stacked, the plurality of sub bodies 11 are fixed by a frame.

Each of the second molds may be identical so that the shutter member 20 formed in each sub body 11 has the same size, shape and position, but the present invention is not limited thereto.

Each of the second cavities may comprise a second projection for forming an accommodating groove, and the shape of the second protrusion is same as that of the shutter member to be formed.

The anti-peeping device according to the present invention can be applied to various display devices, that is, the anti-peeping device according to the present invention is provided on the light exiting surface of a display panel of a display device.

It is to be understood that the above embodiments are merely exemplary embodiments employed for the purpose of illustrating the principles of the present disclosure, but the present disclosure is not limited thereto. It will be apparent to those skilled in the art that various changes and modifications can be made therein without departing from the spirit and spirit of the present disclosure, and such changes and modifications are also regarded to be within the scope of the present disclosure.

1. An anti-peeping device, comprising a transparent body and a plurality of shutter members, a plurality of accommodating grooves for accommodating the shutter members being formed on the transparent body, the shutter members being spaced apart, portions of the transparent body between two adjacent shutter members being light transmitting units, and each of the light transmitting units comprising a light incident surface and a light exiting surface;
wherein, a side of each of the shutter members adjacent to a corresponding accommodating groove is formed as a light reflecting surface which is used to reflect at least a portion of light directed from the light incident surface of a corresponding light transmission unit toward the shutter member, the reflected light is directed toward the light exiting surface of the corresponding light transmission unit, and the light reflecting surface of the shutter member is provided such that an angle between a reflection direction of the light reflected from the light reflecting surface and the light exiting surface of the corresponding light transmission unit is larger than an angle between an incident direction of the light incident on the light reflecting surface and the light incident surface of the corresponding light transmission unit.

2. The anti-peeping device of claim 1, wherein, the light reflecting surface of each of the shutter members is a light reflecting surface of a mirror.

3. The anti-peeping device of claim 1, wherein, the light incident surface of each of the light transmission units is smaller than the light exiting surface of the light transmission unit in a direction perpendicular to the transparent body.

4. The anti-peeping device of claim 3, wherein, a cross section of each of the light transmission units has an isosceles trapezoid shape.

5. The anti-peeping device of claim 1, wherein, each of the shutter members is a triangular prism.

6. The anti-peeping device of claim 1, wherein, the transparent body comprises a plurality of sub bodies stacked in a direction perpendicular to the transparent body, a plurality of accommodating grooves are formed on each of the sub bodies to accommodate the shutter members, and formation positions of the accommodating grooves coincide with each other in the direction perpendicular to the transparent body.

7. The anti-peeping device of claim 6, wherein, each of the light transmitting units comprises a plurality of subunits stacked in the direction perpendicular to the transparent body, each of the subunits corresponds to a portion of a corresponding sub body located between two adjacent shutter members, and each of the subunits comprises a light incident surface and a light exiting surface, in two adjacent subunits positioned in the direction perpendicular to the transparent body, a light exiting surface of a lower subunit is adjacent to a light incident surface of an upper subunit; and
in the direction perpendicular to the transparent body, the light incident surface of each of the subunits is smaller than the light exiting surface of the light transmitting unit.

8. The anti-peeping device of claim 7, wherein, a cross section of each of the subunits has an isosceles trapezoid shape.

9. The anti-peeping device of claim 6, wherein, each of the shutter members is a triangular prism.

10. The anti-peeping device of claim 1, wherein, the shutter members are formed by filling light reflective material in the accommodating grooves.

11. The anti-peeping device of claim 10, wherein, the light reflective material is solid; or the light reflective material is liquid and the anti-peeping device further comprises an encapsulation layer for packaging the light reflective material within the accommodating grooves.

12. The anti-peeping device of claim 1, wherein, each of the shutter members comprises a light reflective material layer provided on an inner wall of each of the accommodating grooves.

13. A method for manufacturing an anti-peeping device, comprising:
preparing a transparent body, forming a plurality of accommodating grooves which are spaced apart on the transparent body; and
forming a shutter member in each of the accommodating grooves, a side of the shutter member adjacent to a corresponding accommodating groove being formed as a light reflecting surface;
wherein, portions of the transparent body between adjacent two shutter members are light transmitting units, each of the light transmitting units comprises a light incident surface and a light exiting surface, the light reflecting surface of each shutter member is used to reflect at least a portion of light directed from the light incident surface of a corresponding light transmission unit toward the shutter member, the reflected light is directed toward the light exiting surface of the corresponding light transmission unit, and the light reflecting surface of the shutter member is provided such that an angle between a reflection direction of the light reflected from the light reflecting surface and the light exiting surface of the corresponding light transmission unit is larger than an angle between an incident direction of the light incident on the light reflecting surface and the light incident surface of the corresponding light transmission unit.

14. The method of claim 13, wherein, the step of preparing a transparent body comprises:
providing a plurality of first molds, each of the first molds comprises a first cavity, a shape of the first cavity is matched to that of the transparent body; and
filling material for forming the transparent body in the first cavity.

15. The method of claim 13, wherein, the step of forming a shutter member comprises:
filling liquid light reflective material in the accommodating groove; and
curing the liquid light reflective material, or providing an encapsulation layer for packaging the light reflective material within the accommodating groove.

16. The method of claim 13, wherein, the step of forming a shutter member comprises:
providing a light reflective material layer provided on an inner wall of each of the accommodating grooves.

17. The method of claim 13, wherein, the transparent body comprises a plurality of sub bodies stacked in a direction perpendicular to the transparent body, a plurality of accommodating grooves for accommodating the shutter members are formed on each of the sub bodies, and the step of preparing a transparent body comprises:
providing a plurality of second molds, each of the second molds comprises a second cavity, a shape of each of the second cavities is matched to that of the transparent body; and
filling material for forming the transparent body in each of the second cavities.

18. The method of claim 17, wherein, the step of forming a shutter member comprises:
filling liquid light reflective material in the accommodating groove of each of the sub bodies; and
curing the liquid light reflective material, and stacking and fixing the plurality of sub bodies in a direction perpendicular to the transparent body.

19. The method of claim 17, wherein, the step of forming a shutter member comprises:
forming a light reflective material layer on inner walls of the accommodating grooves of each of the sub bodies; and
stacking and fixing the plurality of sub bodies in a direction perpendicular to the transparent body.

20. A display device, comprising a display panel and an anti-peeping device, the anti-peeping device being provided on a light exiting surface of the anti-peeping device, and the anti-peeping device comprising a transparent body and a plurality of shutter members, a plurality of accommodating grooves for accommodating the shutter members being formed on the transparent body, the shutter members being spaced apart, portions of the transparent body between two adjacent shutter members being light transmitting units, and each of the light transmitting units comprising a light incident surface and a light exiting surface;
wherein, a side of each of the shutter members adjacent to a corresponding accommodating groove is formed as a light reflecting surface which is used to reflect at least a portion of light directed from the light incident surface of a corresponding light transmission unit toward the shutter member, the reflected light is directed toward the light exiting surface of the corresponding light transmission unit, and the light reflecting surface of the shutter member is provided such that an angle between a reflection direction of the light reflected from the light reflecting surface and the light exiting surface of the corresponding light transmission unit is larger than an angle between an incident direction of the light incident on the light reflecting surface and the light incident surface of the corresponding light transmission unit.
